(19) United States
(12) Patent Application Publication
(10) Pub. No.: US 2005/0229661 A1
(43) Pub. Date: Oct. 20, 2005

(54) Door actuator

(76) Inventor: Wolfgang Kossl, Allhartsberg (AT)

Correspondence Address: BARNES & THORNBURG, 750-17TH STREET NW, SUITE 900, WASHINGTON, DC, 20006, US

(21) Appl. No.: 10/522,670

(22) PCT Filed: Jul. 24, 2003
(86) PCT No.: PCT/EP03/08118

§ 371 Date: Jun. 8, 2005

(30) Foreign Application Priority Data
Jan. 28, 2003 (AT) A1192003
Jul. 31, 2002 (AT) A11692002

(51) Int. Cl. E05B 15/00

(52) U.S. Cl. 70/266

(57) ABSTRACT

A door actuator, in particular the door lock, for rail vehicles, comprising a spindle drive, the spindle of which is connected to a freewheel, permitting rotation in the direction corresponding to the closing of the door and preventing rotation in the direction corresponding to the opening of the door. The part of the freewheel furthest from the spindle is mounted such as to rotate, but with a releasable fixing relative to a release device, achieved by a coupling which may be released by solenoid. The brake, clutch or similar coupling is or may be fixed in the open position and a closing magnet is provided. In a first version, the coupling, is operated by a bar, and between the released position of the bar and the locked position of the bar there is a dead-point. In a second version, the open position is maintained by a permanent magnet.

The invention relates to a door actuator, particularly a door lock, for rail vehicles having a spindle drive whose spindle is connected with a freewheel permitting the rotation of the spindle in the direction corresponding to the closing direction of the door and preventing the rotation of the spindle in the direction corresponding to the opening direction, the part of the freewheel away from the spindle being mounted in a rotatable manner but being releasably fixed with respect to a release device, by means of a coupling, brake or the like, which can be released by means of a lifting magnet against the force of a contact pressure spring.

Numerous rail vehicles have door actuators which contain a spindle drive. In order to permit a closing of the door at any time, also a manual closing, a freewheel is arranged on one end of the spindle, which freewheel permits the rotating of the spindle in the direction corresponding to the closing movement of the door, but prevents a rotating of the spindle in the direction corresponding to the opening movement. In order to nevertheless be able to open the door, the part of the freewheel away from the spindle is rotatably mounted with respect to the body and is generally fixed by a brake, a coupling or the like. When now the door is opened in the course of the normal operation, this brake, coupling or the like is released by a lifting magnet so that the door actuator can rotate the spindle in the direction corresponding to the opening movement of the door, in which case it naturally takes along the entire freewheel. If a manual opening occurs in emergency and danger situations, this brake, the coupling or the like can be released by the door emergency handle and the door can be opened manually.

These doors have been very successful during the operation and, particularly, because of their compact construction, their robust method of operation and their operational reliability, represent a wide-spread standard solution for the doors of rail vehicle.

The lifting magnet represents a certain disadvantage of doors of this type. It has to be activated during each opening of the door for the entire opening time and therefore has to be designed for fairly long operating periods. Since it also has to overcome considerable forces, it is necessary to provide a correspondingly sturdy and therefore large, expensive and current-requiring lifting magnet.

In addition, in the parked condition of the cars, thus, when the door actuator is without current or power, it is difficult for cleaning personnel or inspection personnel to enter the vehicle because, for this purpose, the emergency door handle has to be operated which extends to the outside at a relatively inaccessible point. On the inside, the emergency door handle is naturally provided in the direct vicinity of the door.

According to today's demands, many railroad administrations require that the door actuator has to have an accumulator, in practice, always a condenser which, even 24 hours after the parking of the vehicle, permits the releasing of the brake, coupling or the like by operating a corresponding button and thus the opening of the door. This results in problems when a door is closed again after the opening because, for the opening, a releasing of the brake, the clutch or the like is required under all conditions, but during the second attempt, the condenser is usually already empty.

It is therefore an object of the invention to provide a device by means of which, in the case of a door actuator of the initially mentioned type, the above-mentioned problems do not occur and it becomes possible, in particular to be able to satisfactorily use smaller lifting magnets and to open the door several times by means of the energy stored in the conventional condensers.

According to the invention, these objects are achieved in that the brake, the coupling, or the like is fixed or can be fixed in its open position, and that a closing magnet is provided, preferably in that the lifting magnet has a double-action construction.

In a first variant, the fixing takes place by means of a linkage for the movement of the brake, or coupling or the like which, in the course of the release movement, is guided by way of a dead center. Thus, despite the contact pressure spring, the brake or the coupling will also remain in the open position when the lifting magnet is de-energized.

In a second variant, the brake, coupling or the like or a magnetizable component connected therewith, in the open position, is caused to approach a permanent magnet such that its attraction force will hold the brake open against the force of the contact pressure spring also when the magnet is de-energized.

In this manner, the activating of the lifting magnet is required only during the releasing or locking movement of the brake, coupling or the like, but not for the holding in the open position, and therefore small double-acting magnets can be used which permit several opening operations also by means of conventional condensers.

In the following, the invention will be explained in detail with reference to the drawing.

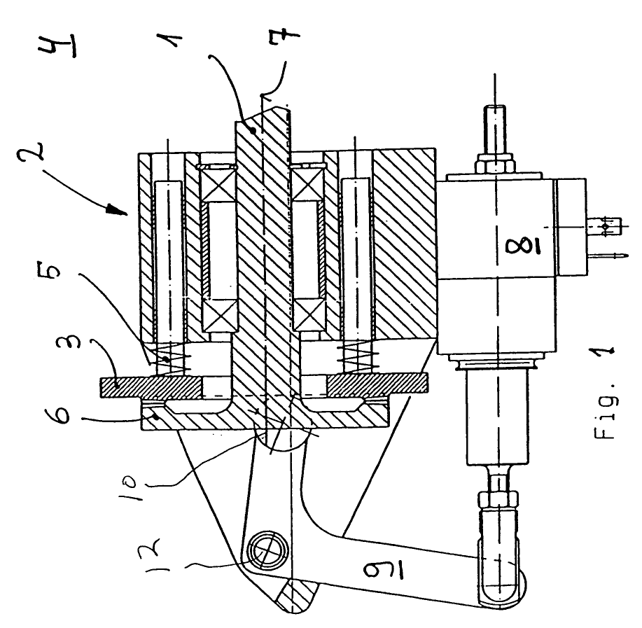

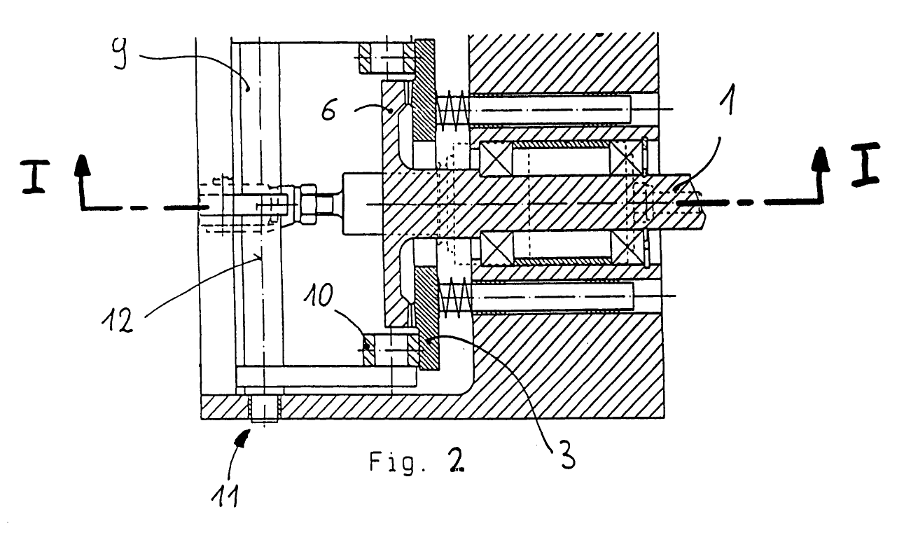

FIG. 1 is a sectional view of a device according to the invention in its released position along Line I-I of FIG. 2;

FIG. 2 is a sectional view of the device of FIG. 1 rotated by 90° with respect to that of FIG. 1;

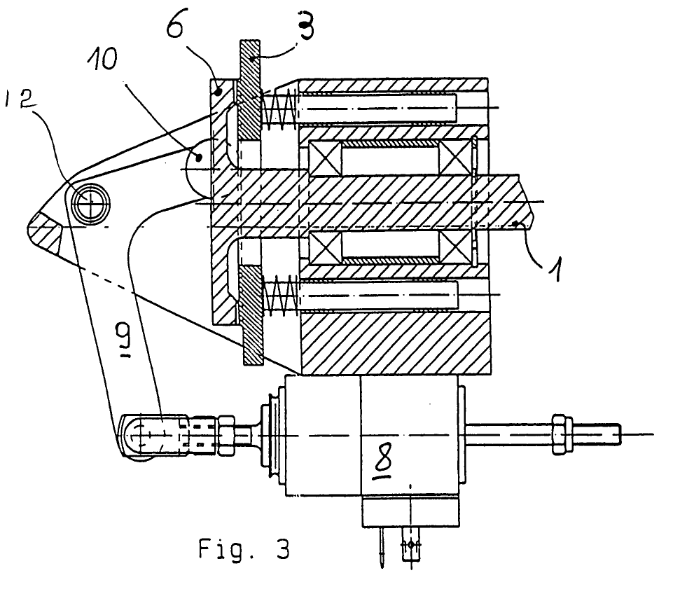

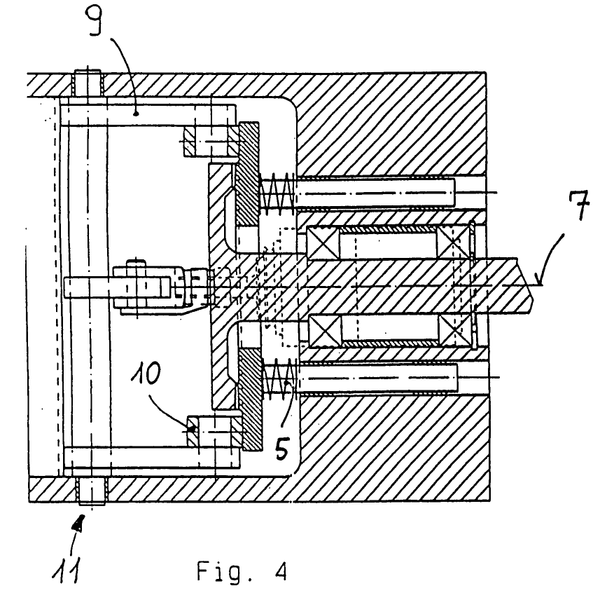

FIGS. 3 and 4 are sectional views of the device according to FIGS. 1 and 2 in the locked condition; and

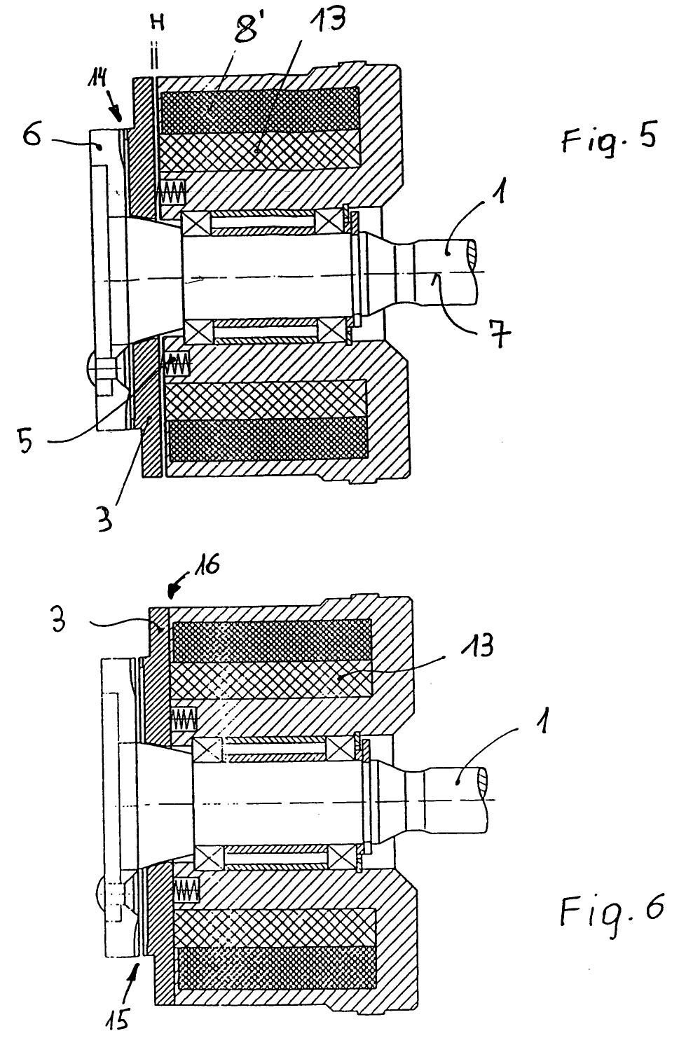

FIGS. 5 and 6 are views of variants of the invention with permanent magnets.

The drawing shows one of the ends of a door actuator of the above-mentioned type in the area of the pertaining release device 2. A spindle 1 of the door actuator, which is connected with the (not shown) end of the freewheel, of the brake, or the like away from the door, which as the above-explained function, carries a toothed spindle disc 6 in a non-rotatable manner. In the illustrated embodiment, the release device 2 consists of a toothed disc 3 which is non-rotatably but axially displaceably arranged with respect to the car body 4 and is pressed by means of contact pressure springs 5 in the direction of the axis 7 of the spindle 1 against the toothed spindle disc 6.

In order to permit the opening of the door, it is know from the prior art to provide a lifting magnet 8 in the case of the release device 2, which lifting magnet 8, by means of a mechanism which, as a whole, is called a linkage or lever 9, moves the non-rotatable toothed disc 3 against the force of the contact pressure springs 5 axially so far away from the toothed spindle disc 6 that, as illustrated in FIG. 1, the combs of the toothing have little play in the axial direction with respect to one another, so that the spindle disc 6 can also rotate in the direction blocked by the (not shown) freewheel. The parts of the freewheel away from the door rotate along in this case, so that the entire freewheel rotates along with the spindle 1.

In the case of the release device 2, it is now provided according to the invention to construct the linkage or the lever 9 such that, in the position in which it disengages the non-rotatable toothed disk 3 sufficiently far, it will also be held when the lifting magnet 8 is de-energized. In the illustrated embodiment this takes place in that, in the course of the releasing movement, the lever 9 arrives over a so-called dead-center position and, also in the end position on the other side of the dead center, as illustrated in FIG. 1, the toothings are in a disengaged position.

The entire mechanism of the lever 9 is clearly illustrated in FIG. 2. It consists of the angular, optionally multipart lever 9, whose hinge is swivellably disposed in the release device 2 in a bearing 11 and, by means of rollers 10, acts upon the periphery of the non-rotatable but axially movable toothed disc 3. The rollers describe a circular arc about the axis of the bearing 11, in which case, as illustrated by the cohesion between FIGS. 1 and 3, in the locked position illustrated in FIG. 3, the toothings of the non-rotatable toothed disc 3 and of the toothed spindle disc 6 are engaged, while, in the position illustrated in FIG. 1, these toothings a spaced away from one another and thus are released.

In order to return from the released position illustrated in FIG. 1 into the locked position, it is, in contrast to the prior art, required to activate the lifting magnet 8 into the other direction, which requires that, instead of a lifting magnet in the actual sense, a reversible lifting magnet or a double-acting magnet be used which now has the purpose of overcoming the dead center because both end positions are maintained in a stable manner.

The invention is not limited to the illustrated embodiment but can also be modified in different fashions. Thus, it is also conceivable to, instead of the over-dead-center mechanism, provide the lifting magnet 8 on its one face with such a strong permanent magnet that it balances the force of the contact pressure springs 5 without the requirement of providing a dead center mechanism in the linkage 9. This can be easily achieved particularly if the rollers 10 or the respective equivalent component in the released position is close to a dead center because then the forces required for the holding will be minimal, in the dead center, theoretically zero.

In the illustrated embodiment, the dead-center mechanism is based on the arrangement of the two end positions of the linkage 9, as illustrated in FIGS. 1 and 3 respectively, in connection with the force and the direction of the force of the contact pressure springs 5. The roller 10, actually its axis of rotation, once takes up a position between the two end positions in which the connection plane between the bearing axis 12 and the axis of rotation extends parallel to the displacing direction of the toothed disc 3 (in the direction of the spring force). This position corresponds to the dead center because, on both sides, as a result of the angular position of the connection plane with respect to the displacing direction, a component of the spring force away from the dead center acts upon the linkage.

In the knowledge of the invention, it is easy for a person skilled in the field of mechanics to find other arrangements which fulfill the same purpose. The variant illustrated in the drawing is not only robust but also permits an easy adjustment and, as a result of the appropriate selection of the length of the lever arms of the lever 9, a favorable translation, so that also, by means an extremely small lifting magnet 8 which consumes only little current, a high force of the contact pressure springs 5 can be overcome, which is easily visible when comparing FIGS. 1 and 3.

FIGS. 5 and 6 show the variant of the invention with at least one, preferably more permanent magnets 13 uniformly arranged along the periphery of a circle in the housing.

FIG. 5 shows the locked position in which an air gap H exists between the housing and the toothed disc 3, but the toothed disc 3, which is non-rotatable with respect to the car body 4, meshes with the toothed spindle disc 6 and thus prevents the rotation of the spindle 1 in the opening direction.

FIG. 6 shows the released position in which the toothing is disengaged, as shown by the tooth gap 15 between the two tooth areas; in contrast, the air gap H is closed; the toothed disc 3 rests against the housing in the contact area 16, or has a minimal distance which can hardly be indicated, because the toothed disc 3 rests on the permanent magnet 13, and can be considered to be a type of yoke. The holding force of the permanent magnets 13 is greater than the force of the contact pressure springs 5, so that, also when the lifting magnets 8′ are switched off, the brake, the coupling or the like remains released in a stable manner.

In order to return into the locked position, the lifting magnets 8′ are energized in the opposite direction; the combined force of the lifting magnets and the contact pressure springs overcomes the attraction force of the permanent magnets; and the position according to FIG. 5 is reached again. In this position, the force of the contact pressure springs 5 (linear power drop as the distance increases) is greater than the attraction force of the permanent magnets (square power drop as the distance increases); and also this position is therefore stable when the lifting magnets 8′ are de-energized.

Thus, every change of the position can be caused by a brief rush of current by the double-acting lifting magnets 8′, or alternatingly by two opposite sets of single-acting lifting magnets, whereby current is saved, on the one hand, and it becomes possible, on the other hand, to use stronger magnets, since their thermal stressing by the brief activation results in no problems.

The toothing between the stationary toothed disc 3 and the toothed spindle disc 6 may have a symmetrical or asymmetrical construction and, in the latter case, may be constructed to be so flat in a direction corresponding to the closing direction of the door that it represents an additional freewheel; that is, that in emergency cases or the like, the user of the door, by means of a defined force against the contact pressure springs 5, can rotate the two discs 3, 6, tooth after tooth against one another. Furthermore, particularly asymmetrical tooth faces make it possible to drive the torque required for the overcoming in the opening direction arbitrarily high. In this case, the mechanical stability and optionally a possibility for an overcoming desired in a not completely released condition may be considered to be the practical boundary.

1. Door actuator, particularly the door lock, of rail vehicles, having a spindle drive whose spindle is connected with a freewheel permitting the rotation of the spindle in the direction corresponding to the closing direction of the door and preventing the rotation of the spindle in the direction corresponding to the opening direction, the part of the freewheel (1) away from the spindle being mounted in a rotatable manner but being releasably fixed with respect to a release device (2) against the force of at least one contact pressure spring (5), by means of a clutch, brake or the like (3, 6), which can be released by means of a lifting magnet (8,8′), and the brake, clutch or the like is fixed or can be fixed in its open position, characterized in that a closing magnet is provided for locking the brake, clutch or the like.

2. Door actuator according to claim 1,
characterized in that the closing magnet and the lifting magnet (8, 8′) are constructed in the shape of a double-acting magnet.

3. Door actuator according to claim 1 or 2,
characterized in that the clutch, brake or the like (3, 6) can be operated by a linkage (9), and in that a dead-center position is present between the released position of the linkage (9) and the locked position of the linkage (9).

4. Door actuator according to claim 3,
characterized in that the linkage (9) has a lever which can be swivelled about an axis (12) and to whose arm the lifting magnet (8) is directly or indirectly applied, and whose other arm directly or indirectly carries rollers (10) with an aligned axis is of rotation parallel to the axis (12) which bring the part (3) of the clutch, brake or the like movable between the released position and the locked position from the locked into the released position, and in that the dead-center position is reached when the connection plane between the axis of rotation of the rollers (10) and the axis (12) is situated parallel to the moving direction of the movable part (3) of the clutch, brake or the like.

5. Door actuator according to one of claims 1 to 4,
characterized in that the part of the clutch, brake or the like movable between the released position and the locked position is a toothed disc (3) which is displaceable with respect to the release device (2) axially against the force of at least one contact pressure spring but is non-rotatable.

6. Door actuator according to claim 1 or 2,
characterized in that, in the released position, the movable part (3) having the ferromagnetic material comes so close to at least one permanent magnet (13), that the attraction force of the permanent magnet (13) exceeds the force of the contact pressure spring (5).

7. Door actuator according to claim 6,
characterized in that the movable part (3) consists at least essentially of ferromagnetic material and, in the released position, rests on at least one permanent magnet (13).

8. Door actuator according to claim 6 or 7,
characterized in that several permanent magnets (13) are provided which are arranged along a circle extending concentrically with respect to the spindle axis (7).
